(19) United States
(12) Patent Application Publication
(10) Pub. No.: US 2019/0335230 A1
(43) Pub. Date: Oct. 31, 2019

(54) WIRELESS INFORMATION TRANSCEIVER SYSTEM

(71) Applicant: NorthVision Technology Inc., Langley (CA)

(72) Inventor: Shih-Hung HSU, Taipei City (TW)

(21) Appl. No.: 16/398,032

(22) Filed: Apr. 29, 2019

(30) Foreign Application Priority Data
Apr. 27, 2018 (TW) 107114400

(51) Int. Cl. H04N 21/4363; H04N 21/41; H04N 21/414

(52) U.S. Cl. CPC H04N 21/43637; H04N 21/41407; H04N 21/4126

(57) ABSTRACT

A wireless information transceiver system is provided, which includes at least one wireless signal transmitter device and a wireless signal receiver device. The wireless signal transmitter device includes: a first receiving module, a first control module, a first output module and a power supply module. The wireless signal receiver device includes: a second receiving module, a second control module and a second output module. The wireless signal transceiver can convert the original image signals of a computer device into non-compressed high-definition image signals by the wireless signal transmitter device. Then, the non-compressed high-definition image signals are transmitted to an image display device via the wireless signal receiver device. Besides, the wireless signal transmitter device further implements the power distribution via the power supply module according to the power consumption level and the temperature.

### REFERENCE TO RELATED APPLICATIONS

The present application is based on, and claims priority from, Taiwan application number 107114400, filed on 27 Apr. 2018, the disclosure of which is hereby incorporated by reference herein in its entirety.

### BACKGROUND OF THE INVENTION

### 1. Field of the Invention

The present invention relates to an information transceiver system, in particular to a wireless information transceiver system wirelessly transmitting information.

### 2. Description of the Prior Art

Nowadays, the electronic industry and the network information technology are greatly advanced, most data are transmitted and displayed by wireless approach instead of wired approach. However, people currently have higher requirement for the quality of image data, so the image data tend to be of high definition and high resolution. For the reason, the data volume of image data are becoming larger, which results in the overload of most currently available wireless information transceiver system. The transmission of image data needs a lot of time. In order to reduce the transmission time for transmitting image data, the original image data should be compressed and then transmitted to a display system. Then, the display system should decompress the compressed image data and then display the image data on a screen. However, the above compression process and the decompression process tend to result in the distortion of the image data. If the currently available wireless information transceiver systems are applied to business brief or video & audio entertainment, the displayed briefs and image data may be delayed and distorted.

Besides, although the currently available wireless information transceiver systems can realize the transmission of 4K high-definition image data up to 60 GHz, the wireless signal transmitter device connected to a computer device should simultaneously be connected to a USB (Universal Serial Bus) port and a HDMI (High Definition Multimedia Interface) port of the computer device because the wireless signal transmitter device needs to be powered by the computer device via the USB port. However, the following problems may be incurred accordingly:

(1) When the computer device fails to connect to an additional power supply, the electricity capacity of the computer device tends to run out in a short time. Thus, when the computer device is implementing a business brief or a video & audio entertainment display, the battery of the computer device may be exhausted before finishing the business brief or the video & audio entertainment display because of high power consumption.

(2) The computer device not only needs to output the image signals to the wireless signal transmitter device, but also needs to power the wireless signal transmitter device even if the computer device is connected to an additional power supply. Therefore, the workload of the computer will be significantly increased, so the loss of the computer device will be increased accordingly.

(3) As the wireless information transceiver system is directly powered by the computer device, so the computer device cannot effectively distribute the electric power for the wireless information transceiver system. Thus, the wireless information transceiver system cannot achieve the most efficient status, which tends to increase the losses of some components thereof.

(4) The wireless signal transmitter device has no the temperature control function, so the temperatures of some modules will increase in the condition of high power consumption. Therefore, some components thereof tend to be swiftly aging because being in high temperature for a long time.

(5) The wireless signal transmitter device should be connected to a USB port and a HDMI port of the computer. However, if the USB ports of the computer device are insufficient, the user cannot conveniently use the device.

Therefore, it has become an important issue to provide a wireless information transceiver system to improve the shortcomings of the currently available wireless information transceiver systems.

### SUMMARY OF THE INVENTION

Therefore, the present invention provides a wireless information transceiver system so as to increase the service life of the system via the design of the power supply module thereof.

To achieve the foregoing objective, the present invention provides a wireless information transceiver system, which includes at least one wireless signal transmitter device and a wireless signal receiver device. The wireless information transceiver system converts the original image signal of a computer device into a non-compressed high-definition image signal, and transmits the non-compressed high-definition image signal to the wireless signal receiver device. Then, the wireless signal receiver device transmits the non-compressed high-definition image signal to an image display device.

In a preferred embodiment, the wireless signal transmitter device includes a first receiving module, a first control module, a first output module and a power supply module. The first receiving module is electrically connected to the computer device; the first receiving module receives an original image signal transmitted from the computer device. The first control module is electrically connected to the first receiving module; the first control module receives the original image signal outputted by the first receiving module and converts the original image signal into a non-compressed high-definition image signal. Then, the first output module electrically connected to the first control module receives and outputs the non-compress high-definition image signal. The power supply module is electrically connected to the first control module and an external power supply device; the power supply module stores the electric power in order to power the first control module, the first receiving module and the first output module, and implements the power distribution according to the power consumption level and the temperature.

In a preferred embodiment, the wireless signal receiver device includes a second receiving module, a second control module and a second output module. The second receiving module receives the non-compressed high-definition image signal outputted from the first output module. Afterwards, the second control module electrically connected to the second receiving module receives and outputs the non-compressed high-definition image signal. Then, the second output module electrically connected to the second control module and an image display device respectively receives the non-compressed high-definition image signal and outputs the non-compressed high-definition image signal to the image display device.

To sum up, the wireless information transceiver system in accordance with the present invention has the following advantages:

(1) The wireless information transceiver system can transmit data via wireless approach, so can directly convert an original image signal outputted from a computer device into a non-compressed high-definition image signal within the receivable range, and an image display device can display the non-compressed high-definition image signal on a real-time basis. Therefore, the problems of delayed images and distortion can be effectively solved.

(2) The wireless signal transmitter device includes a power supply module, so the wireless signal transmitter device can connect to only the HDMI port of a computer device without occupying the USB ports of the computer device.

(3) As the wireless signal transmitter device includes the power supply module, the power consumption of the computer device can be reduced to increase the usage time of the computer device.

(4) The power supply module of the wireless signal transmitter device can prevent from the component losses, resulting from the computer device directly powering the wireless signal transmitter device, of the computer device and the wireless signal transmitter device, and increase the performance of the computer device.

(5) The power supply module of the wireless signal transmitter device can provide the power distribution function and the temperature control function, which can improve the execution efficiency of the wireless signal transmitter device and decrease the component losses.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1 is the block diagram of the wireless signal transmitter device in accordance with the present invention.

FIG. 2 is the block diagram of the wireless signal receiver device in accordance with the present invention.

FIG. 3 is the schematic view of the wireless information transceiver system in accordance with the present invention.

### DETAILED DESCRIPTION OF THE PREFERRED EMBODIMENT

The following description is about embodiments of the present invention; however it is not intended to limit the scope of the present invention.

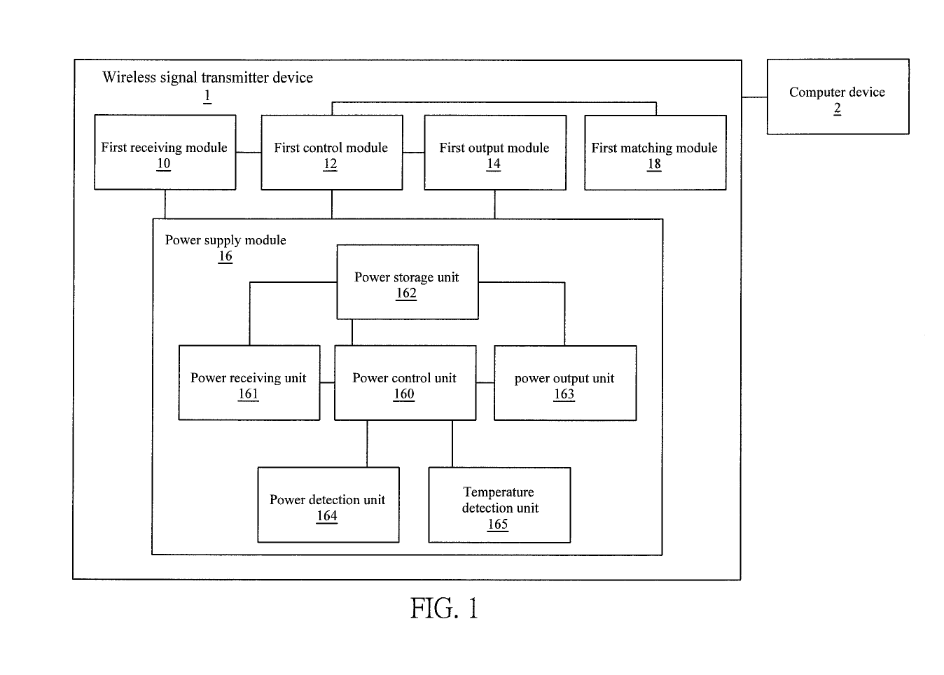

With reference to FIG. 1 for the block diagram of the wireless signal transmitter device in accordance with the present invention, the wireless signal transmitter device 1 includes: a first receiving module 10, a first control module 12, a first output module 14 and a power supply module 16. All the above modules of the wireless signal transmitter device 1 are electrically connected to one another. More specifically, a computer device 2 is electrically connected to the first receiving module 10. The first receiving module 10 is electrically connected to the first control module 12. The first control module 12 is electrically connected to the first output module 14. The power supply module 16 may have two connection relations. For example, the power supply module 16 is electrically connected to the first control module 12 and an external power supply device, or alternatively the power supply module 16 is electrically connected to the first receiving module 10, the first control module 12, the first output module 14 and an external power supply device.

The first receiving module 10 receives a compressed or non-compressed original image signal transmitted from the computer device 1, and outputs the original image signal. Then, the first control module 12 receives the original image signal and converts which into a non-compressed high-definition image signal; the non-compressed high-definition image signal is a 4K high-definition image signal having the transmission frequency of 60 GHz. The power supply module 16 is used to store the electric power so as to power the first receiving module 10, the first control module 12 and the first output module 14, and then implements the power distribution according to the power consumption level and the temperature. In this way, the performance deterioration and the component losses, resulting from the wireless signal transmitter device 1, of the computer device 2 can be reduced. In one embodiment, the electric power provided by the power supply module 16 can power the wireless signal transmitter device 1 for more than 3.5 hours.

In another embodiment, the power supply module 16 further includes: a power control unit 160, a power receiving unit 161, at least one power storage unit 162 and a power output unit 163. All above units are electrically connected to one another. More specifically, the power control unit 160 is electrically connected to the power receiving unit 161, the power storage unit 162 and the power output unit 163. Besides, the power storage unit 162 is also electrically connected to the power receiving unit 161 and the power output unit 163.

The power control unit 160 is used to adjust the electric power and implement the power distribution. The power receiving unit 161 is used to receive the electric power of the external power supply device and output the electric power to the power control unit 160. The power storage unit 162 is used to receive and store the electric power outputted from the power receiving unit 161 to the power control unit 160, or directly receive and store the electric power from the power receiving unit 161; the electric power is outputted from the power output unit 160 or outputted from the power storage unit 162 to the power control unit 160.

In still another embodiment, the power supply module 16 further includes a power detection unit 164. The power detection unit 164 is electrically connected to the first receiving module 10, the first control module 12, the first output module 14, the power control unit 160 and the power storage unit 161 so as to detect the power consumptions of the first receiving module 10, the first control module 12, the first output module 14, and the electricity capacity stored by the power storage unit 162. In addition, the power detection unit 164 outputs a plurality of power consumption level data and an electricity capacity storage information to the power control unit 160. Then, the power control unit 160 can implement the power distribution according to the power consumption level data and the electricity capacity storage information.

The power control unit 160 determines the power consumption levels of the first receiving module 10, the first control module 12 and the first output module 14 according to the power consumption data. When the power consumption levels of the first receiving module 10, the first control module 12 and the first output module 14 exceed a standard power consumption threshold, the power control unit 160 provides an operating speed adjustment information for the first control module 12. The first control module 12 adjusts operating speeds of the first receiving module 10, the first control module 12 and the first output module 14 in order to reduce the power consumption levels thereof to be within the standard power consumption threshold. In this way, all modules can be operated in most efficient status, which can prevent from the component aging problem caused by these components having been in high power consumption status for a long time.

In still another embodiment, the power supply module 16 further includes a temperature detection unit 165. The temperature detection unit 165 is electrically connected to the first receiving module 10, the first control module 12, the first output module 14 and the power control unit 160. The temperature detection unit 165 is used to detect the temperatures of the first receiving module 10, the first control module 12 and the first output module 14, and output a plurality of temperature data to the power control unit 160. Accordingly, the power control unit 160 can implement the power distribution according to the temperature data.

The power control unit 160 determines the temperatures of the first receiving module 10, the first control module 12 and the first output module 14 according to the temperature data. When the temperatures of the first receiving module 10, the first control module 12 and the first output module 14 exceed a standard temperature threshold (in one embodiment, the standard temperature threshold may be 60° C.), the power control unit 160 will implement one or both of the following two processes:

Process 1: provide a power supply reduction information to the power output unit 163 for the power output unit 163 to reduce the electric power supplied to the first receiving module 10, the first control module 12 and the first output module 14 in order to decrease the temperatures thereof to be within the standard temperature threshold.

Process 2: provide an operating speed adjustment information to the first control module 12 for the first control module 12 to reduce the operating speeds of the first receiving module 10, the first control module 12 and the first output module 14 so as to decrease the temperatures thereof to be within the standard temperature threshold.

The power supply module 16 can monitor the temperature of each of these modules, which not only can avoid that the components are swiftly aging because of high temperature caused by high power consumptions of these modules, but also can prevent the wireless signal transmitter device 1 from being burned or exploding because of overheating.

In one embodiment, the power supply module 16 further includes an electricity capacity display unit. The power control unit 160 outputs an electricity capacity storage information to the electricity capacity display unit to display the current electricity capacity of the power supply module 16.

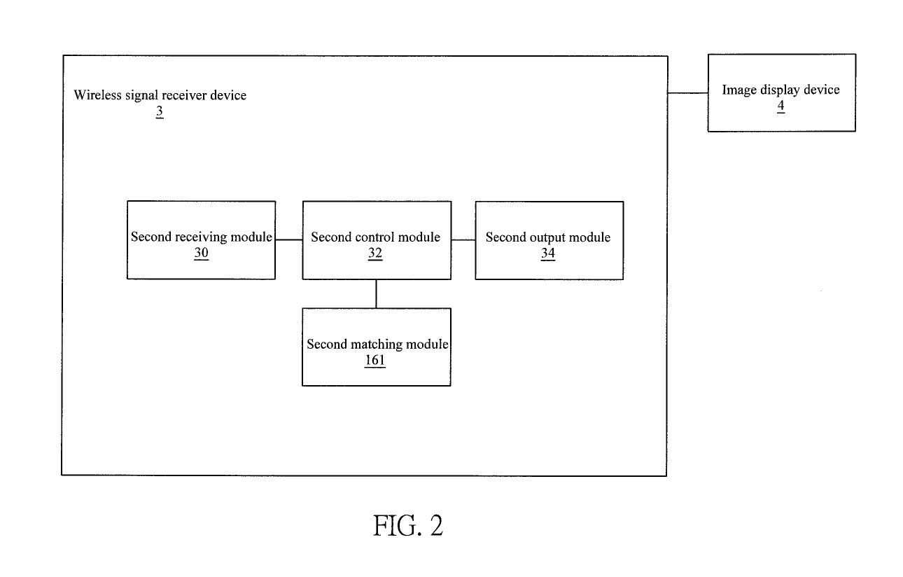

With reference to FIG. 2 for the block diagram of the wireless signal receiver device in accordance with the present invention, the wireless signal receiver device 3 can be integrated with the aforementioned wireless signal transmitter device 1. The wireless signal receiver device 3 includes: a second receiving module 30, a second control module 32 and a second output module 34. The second control module 32 is electrically connected to the second receiving module 30 and the second output module 34 respectively, and receives the non-compressed high-definition image signal, outputted by the first output module 14, from the second receiving module 30. The second control module 32 receives and outputs the non-compressed high-definition image signal to the second output module 34. Then, the second output module 34 transmits the non-compressed high-definition image signal to the image display device 4 electrically connected to the second output module 34.

Moreover, the wireless signal transmitter device 1 further includes a first matching module 18 and the wireless signal receiver device 3 further includes a second matching module 36. The first matching module 18 and the second matching module 36 execute a wireless signal connection with each other. When the first matching module 18 receives a matching instruction, the first matching module 18 outputs a matching request instruction to the second matching module 36. Afterwards, the second matching module 366 executes the wireless signal connection to wirelessly connect to the first matching module 18 after receiving the matching request instruction.

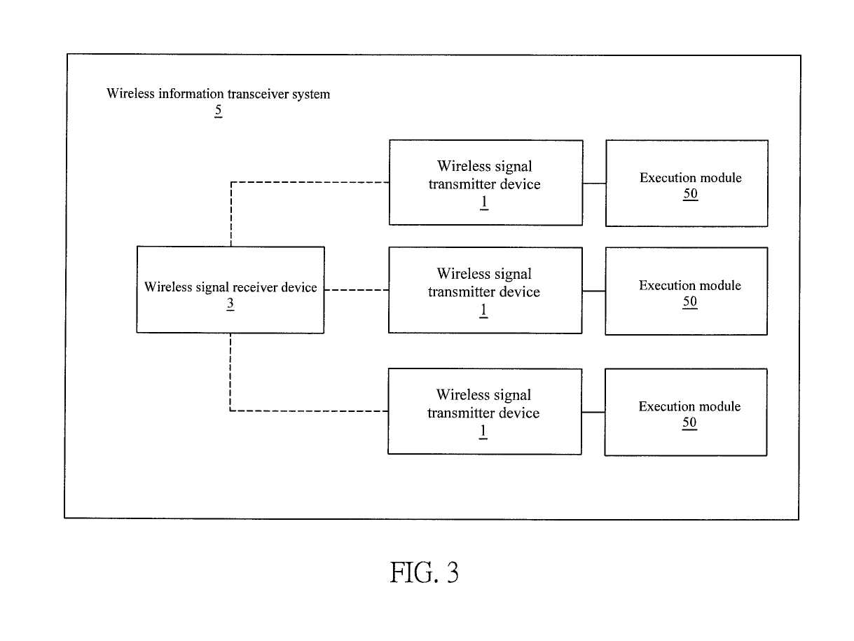

With reference to FIG. 3 for the schematic view of the wireless information transceiver system in accordance with the present invention, the wireless information transceiver system 5 includes at least one wireless signal transmitter device 1 and a wireless signal receiver device 3. The second matching module 36 is connected to only one first matching module 18 at a time point. Thus, if there are more than one first matching module 18 within the receivable range of the second matching module 36, the second matching module 36 will receive the latest matching request instruction transmitted from anyone of the first matching modules 18. In other words, when the second matching module 18 executes the wireless signal connection to one first matching module 18 and simultaneously receives the matching request instruction from another first matching module 18, the second matching module 36 stops executes the wireless signal connection to the former, but executes the wireless signal connection to the latter. Therefore, if the system is applied to a business brief and different users use different wireless signal transmitter devices 1, the speaker can be switched between the users according to the actual requirement.

In one embodiment, the wireless signal transmitter device 1 further includes an execution module 50. The execution module 50 can execute one or both of the following instructions:

Instruction 1: when the execution module 50 receives a display instruction, the first output module 14 transmits the non-compressed high-definition image signal to the second receiving module 30.

Instruction 2: when the execution module 50 receives a stop instruction, the first output module 14 stops transmitting the non-compressed high-definition image signal to the second receiving module 30.

Via the execution module 50, the user can determine to play or stop playing the image without controlling the computer device 2, so the control of the device can be simplified.

The above disclosure is related to the detailed technical contents and inventive features thereof. Those skilled in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

1. A wireless signal transmitter device, comprising:
a first receiving module, electrically connected to a computer device and configured to receive an original image signal transmitted from the computer device;
a first control module, electrically connected to the first receiving module, and configured to receive the original image signal outputted by the first receiving module and convert the original image signal into a non-compressed high-definition image signal;
a first output module, electrically connected to the first control module and configured to receive and output the non-compress high-definition image signal outputted from the first control module;
a power supply module, electrically connected to the first control module and an external power supply device, and configured to store an electric power in order to power the first control module, the first receiving module and the first output module, and implement a power distribution according to a power consumption level and a temperature.

2. The wireless signal transmitter device of claim 1, wherein the power supply module is electrically connected to the first receiving module and the first output module in order to power the first receiving module and the first output module.

3. The wireless signal transmitter device of claim 1, wherein the power supply module further comprises:
a power control unit, configured to adjust the electric power and implement the power distribution;
a power receiving unit, electrically connected to the power control unit, and configured to receive the electric power of the external power supply device and output the electric power to the power control unit;
at least one power storage unit, electrically connected to the power control unit, and configured to receive and store the electric power outputted from the power receiving unit to the power control unit; and
a power output unit, electrically connected to the power control unit and configured to receive the electric power outputted from the power storage unit to the power control unit.

4. The wireless signal transmitter device of claim 3, wherein the power supply module further comprises a power detection unit electrically connected to the first receiving module, the first control module, the first output module, the power control unit and the power storage unit, and configured to detect power consumption levels of the first receiving module, the first control module, the first output module, and an electricity capacity stored by the power storage unit, and output a plurality of power consumption level data and an electricity capacity storage information to the power control unit, whereby the power control unit implements the power distribution according to the power consumption level data or the electricity capacity storage information.

5. The wireless signal transmitter device of claim 3, wherein the power supply module further comprises a temperature detection unit electrically connected to the first receiving module, the first control module, the first output module and the power control unit, configured to detect temperatures of the first receiving module, the first control module and the first output module, and output a plurality of temperature data to the power control unit, whereby the power control unit implements the power distribution according to the temperature data.

6. The wireless signal transmitter device of claim 4, wherein the power control unit determines the power consumption levels of the first receiving module, the first control module and the first output module according to the power consumption data; when the power consumption levels of the first receiving module, the first control module and the first output module exceed a standard power consumption threshold, the power control unit provides an operating speed adjustment information for the first control module; the first control module adjusts operating speeds of the first receiving module, the first control module and the first output module so as to reduce the power consumption levels of the first receiving module, the first control module and the first output module to be within the standard power consumption threshold.

7. The wireless signal transmitter device of claim 4, wherein the power supply module further comprises an electricity capacity display unit; the power control unit outputs the electricity capacity storage information to the electricity capacity display unit to display the electricity capacity of the power supply module.

8. The wireless signal transmitter device of claim 5, wherein the power control unit determines the temperatures of the first receiving module, the first control module and the first output module according to the temperature data; when the temperatures of the first receiving module, the first control module and the first output module exceed a standard temperature threshold, the power control unit provides a power supply reduction information to the power output unit, whereby the power output unit reduces the electric power supplied to the first receiving module, the first control module and the first output module in order to decrease the temperatures thereof.

9. The wireless signal transmitter device of claim 5, wherein the power control unit determines the temperatures of the first receiving module, the first control module and the first output module according to the temperature data; when the temperatures of the first receiving module, the first control module and the first output module exceed a standard temperature threshold, the power control unit provides an operating speed adjustment information for the first control module, whereby the first control module reduces operating speeds of the first receiving module, the first control module and the first output module so as to decrease the temperatures thereof to be within the standard temperature threshold.

10. The wireless signal transmitter device of claim 1, wherein the non-compressed high-definition image signal is a 4K high-definition image signal having a transmission frequency of 60 GHz.

11. A wireless signal receiver device, applicable to be integrated with the wireless signal transmitter device of claim 1, wherein the wireless signal receiver device comprises:
a second receiving module, configured to receive the non-compressed high-definition image signal outputted from the first output module;
a second control module, electrically connected to the second receiving module and configured to receive the non-compressed high-definition image signal outputted from the second receiving module;
a second output module, electrically connected to the second control module and an image display device respectively, and configured to receive the non-compressed high-definition image signal outputted from the second control module, and output the non-compressed high-definition image signal to the image display device.

12. The wireless signal receiver device of claim 11, wherein the wireless signal transmitter device further comprises a first matching module and the wireless signal receiver device further comprises a second matching module configured to execute a wireless signal connection with the first matching module; when the first matching module receives a matching instruction, the first matching module outputs a matching request instruction to the second matching module and the second matching module executes the wireless signal connection to wirelessly connect to the first matching module after the second matching module receives the matching request instruction.

13. A wireless signal transceiver system, comprises at least one of the wireless signal transmitter claim 1 and a wireless signal receiver device comprising,
a second receiving module, configured to receive the non-compressed high-definition image signal outputted from the first output module;
a second control module, electrically connected to the second receiving module and configured to receive the non-compressed high-definition image signal outputted from the second receiving module;
a second output module, electrically connected to the second control module and an image display device respectively, and configured to receive the non-compressed high-definition image signal outputted from the second control module, and output the non-compressed high-definition image signal to the image display device.

14. The wireless signal transceiver system of claim 13, wherein the second matching module is connected to only one the first matching module at a time point.

15. The wireless signal transceiver system of claim 13, wherein the wireless signal transmitter device further comprises an execution module; when the execution module receives a display instruction, the first output module transmits the non-compressed high-definition image signal to the second receiving module.

16. The wireless signal transceiver system of claim 13, wherein the wireless signal transmitter device further comprises an execution module; when the execution module receives a stop instruction, the first output module stops transmitting the non-compressed high-definition image signal to the second receiving module.
